(19) United States
(12) Patent Application Publication
(10) Pub. No.: US 2007/0084939 A1
(43) Pub. Date: Apr. 19, 2007

(54) Systems and methods of controlling a fan coil unit

(76) Inventor: Mingsheng Liu, Omaha, NE (US)

Correspondence Address: MICHAEL BEST & FRIEDRICH, LLP, 100 E WISCONSIN AVENUE, Suite 3300, MILWAUKEE, WI, 53202, US

(21) Appl. No.: 11/584,001

(22) Filed: Oct. 18, 2006

Related U.S. Application Data
(60) Provisional application No. 60/727,812, filed on Oct. 18, 2005.

(51) Int. Cl. B64D 13/00

(52) U.S. Cl. 236/91 D

(57) ABSTRACT

A method of controlling a temperature of one or more zones using a fan. In one embodiment, the method includes inputting a temperature set point and a temperature control band for the one or more zones, initializing the fan to operate at a first speed setting, and determining a relationship between the temperature of the one or more zones, the temperature set point, and the temperature control band. The method also includes modulating a speed of the fan between the first speed setting and at least one second speed setting based at least partially on the determined relationship.

### RELATED APPLICATION

This application claims priority to U.S. Provisional Patent Application Ser. No. 60/727,812, filed on Oct. 18, 2005, the entire contents of which are incorporated herein by reference.

### FIELD

Embodiments of the invention relate generally to temperature control systems and methods.

### BACKGROUND

Fan coil units are often used to control indoor air temperatures. Generally, a fan coil unit includes a water or direct expansion coil, a fan, and ductwork to distribute the air. In some instances, significant energy costs are incurred by fan coil units due to inadequate controls. Additionally, without proper control, air temperatures may not be able to be maintained effectively.

### SUMMARY

In one embodiment, a method of controlling a temperature of one or more zones using a fan includes inputting a temperature set point for the one or more zones and inputting a temperature control band for the one or more zones. The temperature control band represents an acceptable temperature variation of the one or more zones. The method also includes initializing the fan to operate at a first speed setting, determining a relationship between the temperature of the one or more zones, the temperature set point, and the temperature control band, and modulating a speed of the fan between the first speed setting and a second speed setting based at least partially on the determined relationship. The first speed setting is less than the second speed setting. The fan speed is set to the second speed setting as the temperature of the one or more zones exceeds a sum of the temperature set point and at least a portion of the temperature control band. The fan speed is set to the first speed setting as the temperature of the one or more zones approaches the temperature set point.

In another embodiment, a fan control system configured to control a fan and an air temperature control mechanism for controlling a temperature of one or more zones, includes an input module, a fan speed control module, and an air temperature control module. The input module receives a signal from a temperature sensor which generates a signal indicative of the temperature of the one or more zones; receives a signal from a temperature selection device which allows a user to select a temperature set point for the one or more zones; and stores a control band parameter representing an acceptable temperature variation of the one or more zones. The fan speed control module modulates the fan speed between a first speed setting and a second speed setting, the second speed setting being greater than the first speed setting. The fan speed control module initially operates the fan to the first speed setting, switches the fan speed to the second speed setting upon the temperature of the one or more zones exceeding the sum of the temperature set point and the control band parameter, and switches back to the first speed setting upon the temperature of the one or more zones returning to the sum of the temperature set point and the control band parameter. The air temperature control module modulates the temperature of the air temperature control mechanism to maintain the temperature of the one or more zones at approximately the temperature set point.

In another embodiment, a method of programming a temperature control system controller for controlling the temperature of one or more zones includes programming a first temperature control loop and a second temperature control loop. The first control loop initially operates a fan at a first speed setting, increases the fan speed to a second speed setting upon the temperature of the zone exceeding a sum of a temperature set point and at least a portion of a temperature control band, and decreases the fan speed to the first speed setting upon the temperature of the one or more zones returning to the temperature set point. The second temperature control loop maintains the temperature of the one or more zones at the temperature set point by decreasing the temperature of the air temperature control mechanism upon the temperature of the one or more zones exceeding a sum of the temperature set point and at least a portion of the control band, and increasing the temperature of the air temperature control mechanism upon the temperature of the one or more zones returning to the temperature set point.

Embodiments herein can be implemented in new control systems or retrofitted into existing systems. Further, embodiments can be useful in a host of temperature-controlled environments, such as, for example, industrial production facilities, medical buildings, manufacturing assemblies, laboratories, and ships.

Other aspects of the invention will become apparent by consideration of the detailed description and accompanying drawings.

### BRIEF DESCRIPTION OF THE DRAWINGS

FIG. 1 is a schematic diagram of a portion of a multi-speed fan coil unit (“FCU”) according to an embodiment of the invention.

FIG. 2 is a block diagram of a controller according to an embodiment of the invention.

FIG. 3 illustrates a process for controlling a two-speed fan according to an embodiment of the invention.

FIG. 4 illustrates a process for controlling a three-speed fan according to an embodiment of the invention.

FIG. 5 illustrates a process for controlling an air temperature control mechanism according to an embodiment of the invention.

FIG. 6 illustrates a process for controlling a fan according to an embodiment of the invention.

FIG. 7 illustrates a process for controlling an air temperature control mechanism according to an embodiment of the invention.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

As should also be apparent to one of ordinary skill in the art, the systems shown in the figures are models of what actual systems might be like. Many of the modules and logical structures described are capable of being implemented in software executed by a microprocessor or a similar device or of being implemented in hardware using a variety of components including, for example, application-specific integrated circuits (“ASICs”). Terms like “controller” may include or refer to both hardware and/or software. Furthermore, throughout the specification, capitalized terms are used. Such terms are used to conform to common practices and to help correlate the description with the coding examples, equations, and/or drawings. However, no specific meaning is implied or should be inferred simply due to the use of capitalization. Thus, the claims should not be limited to the specific examples or terminology or to any specific hardware or software implementation or combination of software or hardware.

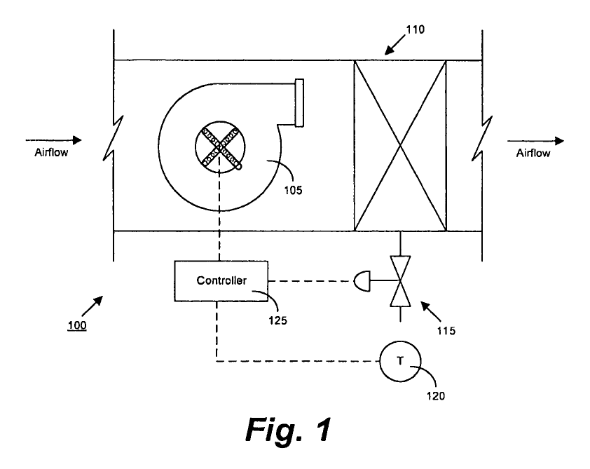

FIG. 1 illustrates a portion of a multi-speed fan coil unit (“FCU”) 100 having a multi-speed fan 105, a coil 110, a valve 115, a temperature sensor 120, and a controller 125. In other embodiments, the FCU 100 may have more or fewer components than those shown in FIG. 1. For example, in an alternative embodiment, the FCU 100 includes two coils 110 and two valves 115. Other variations are possible. As shown in FIG. 1, air flows through the fan 105 and past the coil 110.

The multi-speed fan 105 of the FCU 100 supplies airflow to the one or more zones that the FCU services. In one embodiment, this is accomplished using a series of fan blades, as known in the art. As such, the size, operating speed, and capacity of the fan 105 may vary according to the application. In some embodiments, the coil 110 is a water or direct expansion coil that is used to cool the airflow passing over the coil 110. In other embodiments, the coil 110 can be used to heat the air passing over the coil 110. The valve 115 controls the amount of water or other liquid that is supplied to the coil 110. Accordingly, the valve 115 can effectively control the temperature of the coil 110. For example, in one embodiment, if the valve 115 is in a completely closed position, little or no liquid is supplied to the coil 110, and the coil 110 is allowed to attain room temperature. Alternatively, if the valve 115 is in a fully open position, a maximum amount of liquid is supplied to the coil 110, and maximum cooling is attained. The valve 115 transmits and receives signals from the controller 125, as described in greater detail below. The temperature sensor 120 measures the temperature of the zone to which the FCU 100 is supplying airflow. In some embodiments, the temperature sensor 120 is a stand-alone thermometer that transmits a signal indicative of the zone temperature to the controller 125. In other embodiments, the temperature sensor 120 is integrated into or coupled to the controller 125, for example, forming a single control and sensing unit (e.g., a thermostat device).

Generally, the controller 125 can be a variety of suitable electronic devices, such as, for example, one or more integrated circuits (“ICs”), a microcomputer, a programmable logic controller (“PLC”), and/or other computing device. As such, the controller 125 may include both hardware and software components, and is meant to broadly encompass the combination of such components. In the embodiment shown in FIG. 1, the controller 125 receives signals from the fan 105, the valve 115, and the temperature sensor 120, and transmits signals to the fan 105 and valve 115. In some embodiments, the signals received by the controller 125 are used to generate the signals that are transmitted from the controller 125. For example, as described in greater detail below, the controller 125 may receive a temperature signal from the temperature sensor 120, and use that signal to generate a speed control signal that is transmitted to the fan 105. Additionally, in other embodiments, the controller 125 may be in communication with other components of the FCU 100 (e.g., other controllers, fans, temperature sensors, etc.).

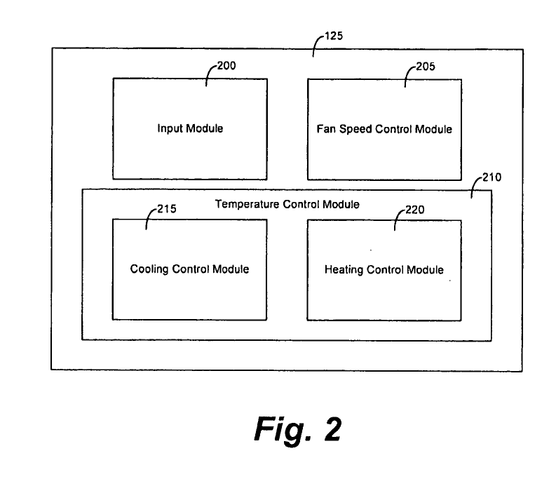

FIG. 2 is a block diagram of the controller 125 of FIG. 1. In the embodiment shown in FIG. 2, the controller 125 includes an input module 200, a fan speed control module 205, and a temperature control module 210 having a cooling control module 215 and a heating control module 220. In other embodiments, the controller 125 may include a variety of other processing and/or memory modules, as should be apparent to one of ordinary skill in the art.

Generally, the input module 200 receives signals from components of the FCU 100, which signals can then be used by the other modules. In some embodiments, the input module 200 also stores certain parameters that are used by the other modules. For example, in one embodiment, the input module 200 receives, from the temperature sensor 120, a signal indicative of the temperature of the zone to which the FCU 100 is supplying airflow. The input module 200 also receives a signal from a temperature selection device (e.g., a thermostat), which allows a user to select a temperature set point, or desired temperature, of the zone. Additionally, a user can store a control band parameter in the input module 200 that represents an acceptable temperature variation of the one or more zones. In other embodiments, the input module 200 also receives a signal from the fan 105 that is indicative of fan speed, and a signal from the valve 115 that is indicative of valve position.

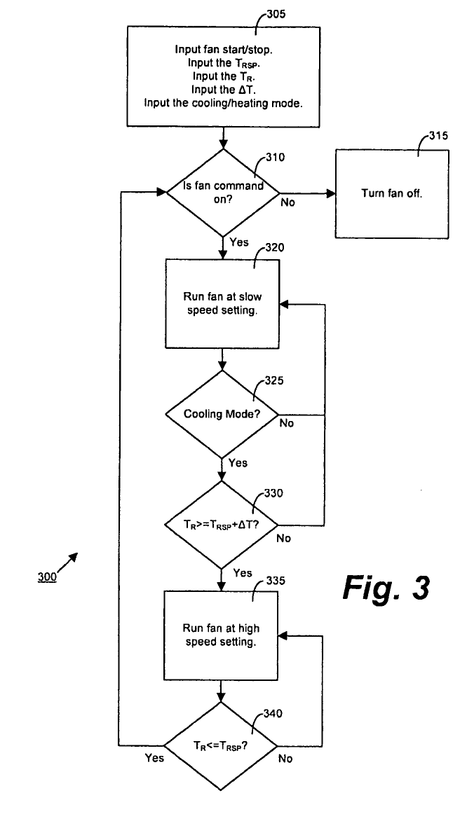

The fan speed control module 205 controls the speed at which the fan 105 operates. In some embodiments, the fan speed control module 205 stores a set of rules or processes (e.g., the processes described with respect to FIGS. 3-7) that can be used to determine a proper fan speed setting. After determining the proper fan speed, the fan speed control module 205 can transmit a control signal to the fan 105. Generally, the fan speed control module 205 modulates the fan speed between a first speed setting and one or more other speed settings, in order to maintain the lowest fan speed possible while maintaining the zone temperature set point.

The temperature control module 210 modulates the temperature of the coil 110. More specifically, the temperature control module 210 modulates the temperature of the coil 110 by modulating the position of the valve 115. In some embodiments, cold and hot controls may be separated, such that the cooling control module 215 is used to control the flow of cold liquid through the coil 110, and the heating control module 220 is used to control the flow of hot liquid through the coil 110. In other embodiments, the cooling control module 215 and the heating control module 220 are not separated. Similar to the fan speed control module 205, in some embodiments, the temperature control module 210 stores one or more sets of rules or processes (e.g., the processes described with respect to FIGS. 3-7) that can be used to determine the proper valve position. After determining the proper valve position, the temperature control module 210 transmits a control signal to the valve 115 to adjust the valve position. Generally, the temperature control module 210 modulates the temperature of the coil 110 to maintain the temperature of the one or more zones at approximately the temperature set point. In some embodiments, the temperature control module 210 and the fan speed control module 205 operate in conjunction with each other, such that the calculations completed by the temperature control module 210 can be utilized by the fan speed control module 205, and vice versa.

FIGS. 3-7 illustrate a variety of processes that can be implemented to control certain functions of an FCU to provide conditioned air to one or more zones. By way of example only, the processes shown in FIGS. 3-7 are described as being carried out by the FCU 100, shown in FIG. 1. However, as should be apparent to one of ordinary skill in the art, the processes shown in FIGS. 3-7 are capable of being implemented by a variety of FCUs. For example, in each of the processes shown in FIGS. 3-7, multiple parameters are described as being input into the controller 125. However, in other embodiments, an alternative controller of an alternative FCU may be used. Further, the specific multipliers (e.g., fractions) set forth in connection with the temperature control band are merely examples.

FIG. 3 illustrates a process 300 for controlling a two-speed fan. The process 300 begins by inputting a variety of parameters into the controller 125 (step 305). In some embodiments, parameters are input by a user into the controller 125 using an input device, such as, for example, a thermostat. In other embodiments, the parameters may be programmed into the controller 125, for example, into a memory of the controller 125. In the embodiment shown in FIG. 3, a fan start/stop command, a zone temperature set point (“T_{RSP}”), a zone temperature (“T_{R}”), a cooling/heating mode, and a temperature control band (“ΔT”) are inputs to the controller 125. The fan start/stop command, zone temperature set point, and cooling/heating mode are input into the controller 125 by a user using a thermostat device. The zone temperature signal is provided to the controller 125 by the temperature sensor 120. The temperature control band, which represents an acceptable temperature variation of the one or more zones, is programmed and stored within the controller 125.

After providing the necessary inputs, the next step in the process 300 is to check if a fan command is on (step 310). As described above, the fan start/stop command can be input by a user with an input device such as a thermostat. In another embodiment, the fan start/stop command may be automatically controlled by the controller 125. For example, if the temperature of the zone that is being conditioned falls below a predetermined temperature, the fan command can be automatically initialized. If the fan command is not on, the fan 105 is turned off (step 315). If the fan command is on, the fan 105 is initialized to run at the slow speed setting (step 320). After the fan 105 has been initialized and is running at the slow setting, the mode (e.g., heating mode or cooling mode) is determined (step 325). In one embodiment, the heating or cooling mode is selected automatically by the controller 125 according to the temperature of the zone. For example, if the zone temperature is above the zone temperature set point, the controller 125 automatically selects the cooling mode. Similarly, if the zone temperature is below the zone temperature set point, the controller 125 automatically selects the heating mode. In other embodiments, a user may be able to manually select the heating or cooling mode using an input device. If the controller 125 is not in the cooling mode, the process 300 returns to step 320, and the fan 105 continues to run at slow speed. If the controller 125 is in the cooling mode, the next step in the process 300 is to check whether the zone temperature is greater than or equal to the combination or sum of the zone temperature set point and a control band. In some embodiments, the zone temperature set point is approximately 72 to 74 degrees Fahrenheit and the control band is approximately ±1 degree Fahrenheit. In other embodiments, however, the zone temperature set point and control band may be set to other values. For example, in one embodiment, a user can select the zone temperature set point using a thermostat device.

If the zone temperature is less than the sum of the temperature set point and the control band, the process 300 returns to step 320, and the fan 105 continues to run at the slow speed setting. If, however, the zone temperature is greater than or equal to the sum of the temperature set point and the control band, the fan speed is increased to a higher speed setting (step 335). The higher speed setting supplies the zone that the FCU 105 is conditioning with a greater amount of cooled air, thereby increasing the speed at which the zone is cooled. After switching to the higher speed setting, the process continues by checking whether the zone temperature is less than or equal to the zone temperature set point (step 340). If the zone temperature has not reached the zone temperature set point, the process 300 returns to step 335, and the fan 105 continues to operate at the higher speed setting. Upon the zone temperature reaching the zone temperature set point, the process 300 returns to step 310, and the fan 105 returns to operating at a slower speed setting. The process 300 continues to be evaluated until the fan command is turned off.

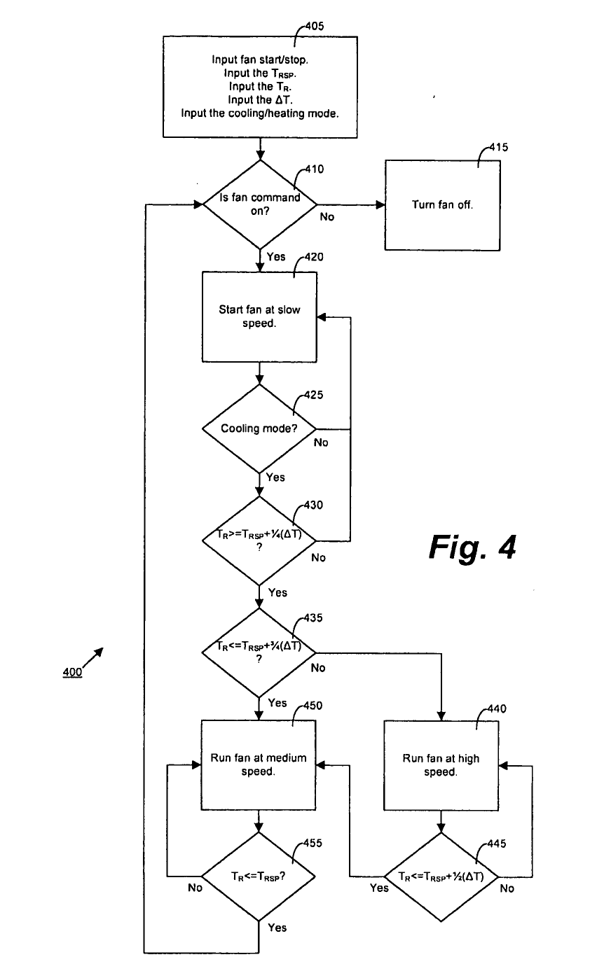

FIG. 4 illustrates a process 400 for controlling a three-speed fan. The first steps of the process 400 are similar to those shown in FIG. 3. For example, the first step of the process is to input the fan start/stop command, the zone temperature set point, the zone temperature, the cooling/heating mode, and the temperature control band (step 405). The next step of the process 400 is to check if the fan command is on (step 410), and if the fan command is not on, to turn the fan off (step 415). If the fan command is on, the fan begins to operate at a slow speed setting (step 420), and the mode is determined (step 425). If the cooling mode is not selected, the process returns to step 420, and the fan remains at the slow speed setting. If the cooling mode is selected, the controller 125 checks if the zone temperature is greater than or equal to the sum of the zone temperature set point and one quarter of the control band (step 430). If the zone temperature has not met or exceeded the sum of the zone temperature set point and one quarter of the control band, the process 400 returns to step 420, and the fan continues to operate at the slow speed setting. If, however, the zone temperature has met or exceeded the sum of the zone temperature set point and one quarter of the control band, the controller 125 checks if the zone temperature is less than or equal to the sum of the zone temperature set point and three quarters of the control band (step 435). If the zone temperature has exceeded the sum of the zone temperature set point and three quarters of the control band, the fan speed is increased to operate at the highest speed setting (step 440), and remains at the highest speed setting until the zone temperature is less than or equal to the sum of the zone temperature set point and one half of the control band (step 445). Upon the temperature falling to the sum of the zone temperature set point and one half of the control band, the fan speed is decreased to the middle or medium speed setting (step 450).

Returning to step 435, if the temperature of the zone is greater than or equal to the sum of the zone temperature set point and one quarter of the control band (step 430), but less than or equal to the sum of the zone temperature set point and three quarters of the control band (step 435), the fan speed is increased to the middle speed setting (step 450), and remains at the medium speed setting until the zone temperature is less than or equal to the zone temperature set point (step 455). Upon the temperature falling to the zone temperature set point, the process 400 returns to step 410, and the speed of the fan is reduced to the slowest speed setting. The process 400 continues to be evaluated until the fan command is turned off.

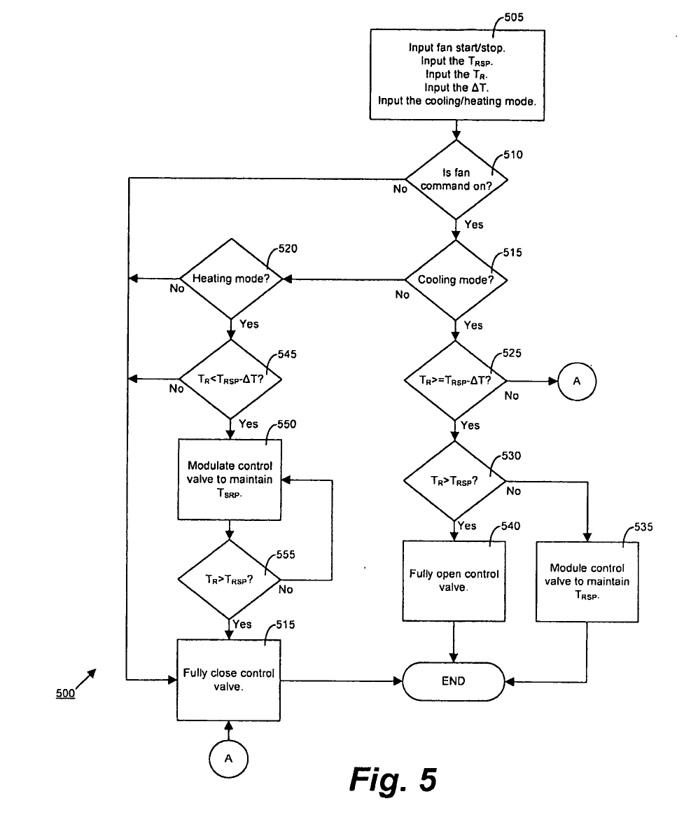

FIG. 5 illustrates a process 500 for controlling an air temperature control mechanism, such as, for example, the coil 110. More specifically, the process 500 is used to control the valve 115 that controls the temperature of the coil 110. In some embodiments, the process 500 is completed concurrently with the processes shown in FIGS. 3-4, such that the speed of the fan 105 and the temperature of the coil 110 are modulated concurrently. In other embodiments, the control valve 115 may be controlled completely independently of the fan 105. Similar to the processes shown in FIGS. 3-4, the first step of the process 500 is to input the fan start/stop command, the zone temperature set point, the zone temperature, the cooling/heating mode, and the temperature control band (step 505). The next step of the process 500 is to check if the fan command is on (step 510). If the fan command is not on, the control valve is closed completely (step 515). In some embodiments, closing the control valve completely allows the coil 110 to warm to room temperature (i.e., the coil 110 does not provide any cooling). If the fan command is on, the mode is determined by first checking if the cooling mode has been activated (step 515). If the cooling mode is not activated, the controller 125 determines if the heating mode has been activated (step 520). If neither the heating mode nor the cooling mode is activated, the valve 115 is fully closed (step 515).

If the cooling mode is activated (step 515), the controller 125 checks if the zone temperature is greater than or equal to the zone temperature set point less the control band (step 525). If the zone temperature is less than the zone temperature set point less the control band, the valve 115 is fully closed (step 515). If, however, the zone temperature is greater than or equal to the zone temperature set point less the control band, the controller 125 checks if the zone temperature is greater than the zone temperature set point (step 530). If the zone temperature is less than or equal to the zone temperature set point, the position of the valve is modulated to maintain the zone temperature set point within the zone (step 535). This position modulation can be accomplished using a variety of methods including, for example, a proportional integral (“PI”) control loop. If the zone temperature is greater than the zone temperature set point, the valve 115 is opened completely (step 540) to attain the greatest potential cooling.

If the heating mode is activated (step 520), the controller 125 checks if the zone temperature is less than the zone temperature set point less the control band (step 545). Additionally, if the heating mode is activated, the coil 110 may be operated such that air passing over the coil 110 is heated. For example, upon activation of the heating mode, hot liquid, such as water, can be passed through the coil 110 so that the coil 110 substantially heats the air. In another embodiment, the FCU 100 can include two separate coils, with one coil being activated with the cooling mode and the other coil being activated with the heating mode. If the zone temperature is greater than or equal to the zone temperature set point less the control band, the valve 115 is closed completely (step 515). If, however, the zone temperature is less than the zone temperature set point less the control band, the valve 115 is modulated to maintain the zone temperature set point (step 550). As described with respect to the cooling mode above, the valve 115 can be modulated according to a PI control loop or other suitable control scheme. The process 500 continues by checking if the zone temperature is greater than the zone temperature set point (step 555). If the zone temperature is less than or equal to the zone temperature set point, the process 500 returns to step 550, and the valve 115 continues to be modulated to maintain the zone temperature set point. If the zone temperature is greater than the zone temperature set point, the valve is closed (step 515). Upon completion, the process 500 can be repeated as needed to control the temperature of the zone.

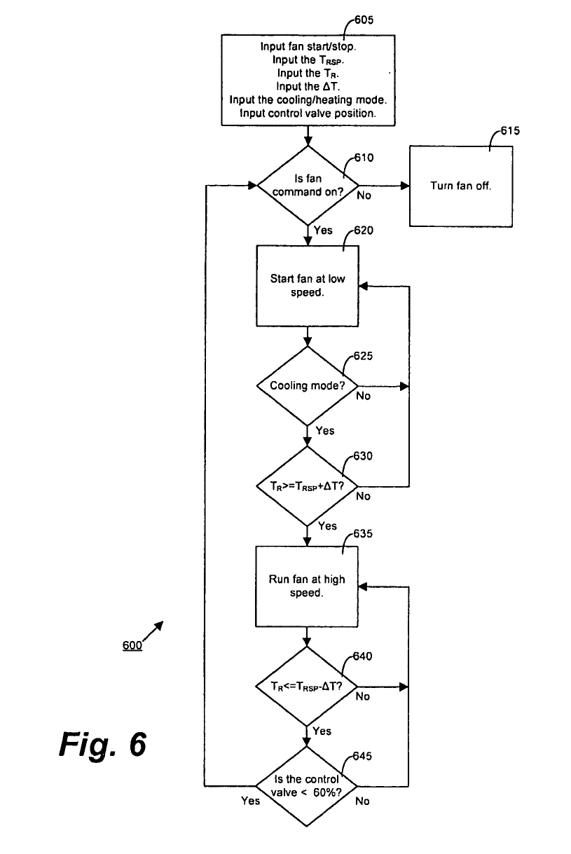

FIG. 6 illustrates a process 600 for controlling a fan and an air temperature control mechanism. The embodiment shown in FIG. 6 is similar to that shown in FIG. 3. The first step of the process 600 is to input the fan start/stop command, the zone temperature set point, the zone temperature, the cooling/heating mode, the temperature control band, and a valve position (step 605). Steps 610-635 are essentially the same as steps 310-335 and will not be specifically addressed in regard to FIG. 6. After operating the fan at the high speed setting (step 635), the controller 125 checks if the zone temperature is less than or equal to the zone temperature set point less the control band (step 640). If the zone temperature is greater than the zone temperature set point less the control band, the process 600 returns to step 635, and the fan continues to operate at the high speed setting. If the zone temperature is less than or equal to the zone temperature set point less the control band, the controller 125 checks if the control valve position is less than 60 percent of the completely open position (step 645). If the control valve is not positioned less than 60 percent of the completely open condition, the process 600 returns to step 635, and the fan continues to operate at the high speed setting. If the position of the control valve is less than 60 percent of the completely open position, the process 600 returns to step 610, and the fan speed is slowed to the low speed setting (step 620) provided that the fan command is on. The process 600 continues to be evaluated until the fan command is turned off.

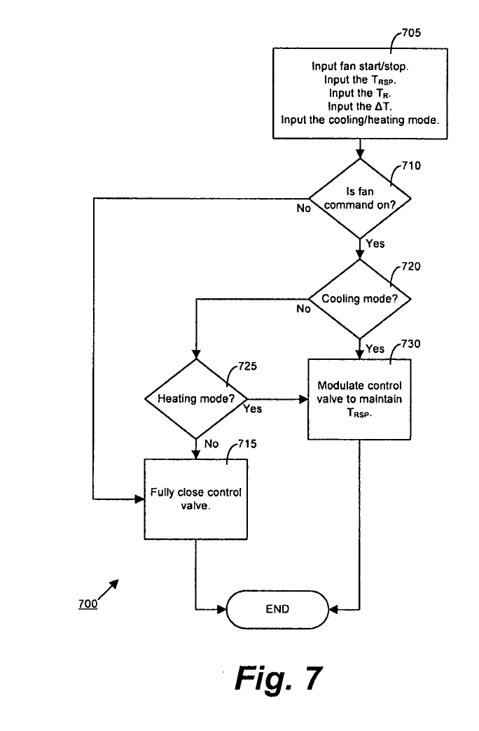

FIG. 7 illustrates another process 700 for controlling an air temperature control mechanism, such as, for example, the coil 110. More specifically, the process 700 is used to control the valve 115 that controls the temperature of the coil 110. Similar to the processes described above, the first step of the process is to input the fan start/stop command, the zone temperature set point, the zone temperature, the cooling/heating mode, and the temperature control band (step 705). The next step in the process 700 is to determine if the fan command is on (step 710). If the fan command is not on, the valve is positioned in the fully closed position (step 715). If the fan command is on, the controller 125 checks if the cooling mode is activated (step 720). If the cooling mode is not activated, the controller 125 checks if the heating mode is activated (step 725). If the heating mode is not activated, the valve 115 is positioned in the fully closed position (step 715). If either the heating mode is activated (step 725), or the cooling mode is activated (step 720), the valve 115 is modulated to maintain the zone temperature at the zone temperature set point (step 730). This can be completed, as previously described, by a variety of suitable methods. Upon completion, the process 700 can be repeated as needed to control the temperature of the zone.

In some embodiments, each of the processes illustrated in FIGS. 3-7 can be carried out independently of one another. In other embodiments, as previously described, two or more of the processes may be carried out concurrently. Additionally, each of the processes shown in FIGS. 3-7 may be stored within the controller 125 such that they can be selected or deselected (i.e., turned “on” or “off”) by a user. For example, a user could access the controller 125 and select the one or more processes that are best suited for conditioning a particular zone.

Various features and advantages of the invention are set forth in the following claims.

What is claimed is:

1. A method of controlling a temperature of one or more zones using a fan, the method comprising:
inputting a temperature set point for the one or more zones;
inputting a temperature control band for the one or more zones, the temperature control band representing an acceptable temperature variation of the one or more zones;
initializing the fan to operate at a first speed setting;
determining a relationship between the temperature of the one or more zones, the temperature set point, and the temperature control band; and
modulating a speed of the fan between the first speed setting and a second speed setting based at least partially on the determined relationship, the first speed setting being less than the second speed setting, the fan speed being set to the second speed setting upon the temperature of the one or more zones exceeding a sum of the temperature set point and at least a portion of the temperature control band, the speed of the fan being set to the first speed setting upon the temperature of the one or more zones approaching the temperature set point.

2. The method of claim 1, further comprising providing an air cooling mechanism and modulating the temperature of the air cooling mechanism to maintain the temperature of the one or more zones at approximately the temperature set point.

3. The method of claim 1, further comprising providing an air heating mechanism and modulating the temperature of the air heating mechanism to maintain the temperature of the one or more zones at approximately the temperature set point.

4. The method of claim 1, further comprising modulating the fan speed between the first speed setting, the second speed setting, and a third speed setting, the third speed setting being greater than both the first speed setting and the second speed setting.

5. The method of claim 4, wherein determining a relationship includes evaluating whether the temperature of the one or more zones is less than a sum of the temperature set point and approximately 25 percent of the control band and operating the fan at the first speed setting when the temperature of the one or more zones is less than the sum.

6. The method of claim 4, wherein determining a relationship includes evaluating whether the temperature of the one or more zones is less than a sum of the temperature set point and approximately 75 percent of the control band and operating the fan at the third speed setting when the temperature of the one or more zones exceeds the sum.

7. The method of claim 6, further comprising decreasing the fan speed from the third speed setting to the second speed setting upon the temperature of the one or more zones falling to a sum of the temperature set point and approximately 50 percent of the control band.

8. A fan control system configured to control a fan and an air temperature control mechanism for controlling a temperature of one or more zones, the fan control system comprising:
an input module configured to receive a signal from a temperature sensor which generates a signal indicative of the temperature of the one or more zones, to receive a signal from a temperature selection device which allows a user to select a temperature set point for the one or more zones, and to store a control band parameter representing an acceptable temperature variation of the one or more zones;
a fan speed control module configured to modulate the fan speed between a first speed setting and a second speed setting, the second speed setting being greater than the first speed setting, wherein the fan speed control module is configured to initially operate the fan to the first speed setting, switch the fan speed to the second speed setting upon the temperature of the one or more zones exceeding the sum of the temperature set point and the control band parameter, and switch back to the first speed setting upon the temperature of the one or more zones returning to the sum of the temperature set point and the control band parameter; and
an air temperature control module configured to modulate the temperature of the air temperature control mechanism to maintain the temperature of the one or more zones at approximately the temperature set point.

9. The fan control system of claim 8, wherein the fan speed control module is further configured to modulate the fan speed between the first speed setting, the second speed setting, and a third speed setting.

10. The fan control system of claim 9, wherein the fan speed control module is further configured to reduce the fan speed from the third speed setting to the second speed setting, and from the second speed setting to the first speed setting, as the temperature of the one or more zones decreases from a temperature greater than the temperature set point to the temperature set point.

11. The fan control system of claim 9, wherein the fan speed control module is further configured to increase the fan speed from the first speed setting to the third speed setting upon the temperature of the one or more zones exceeding a sum of the temperature set point and approximately 75 percent of the control band parameter.

12. The fan control system of claim 11, wherein the fan speed control module is further configured to increase the fan speed from the first speed setting to the second speed setting upon the temperature of the one or more zones exceeding a sum of the temperature set point and approximately 25 percent of the control band parameter but less than the sum of the temperature set point and approximately 75 percent of the control band parameter.

13. The fan control system of claim 8, wherein the air temperature control mechanism comprises one or more cold water coils associated with a valve.

14. The fan control system of claim 13, wherein the air temperature control module is further configured to control the position of the valve.

15. The fan control system of claim 8, wherein the temperature sensor and the temperature selection device are incorporated into a thermostat device.

16. The fan control system of claim 8, wherein the control band parameter is approximately two degrees.

17. A method of programming a temperature control system controller for controlling the temperature of one or more zones, the method comprising:
programming a first temperature control loop, the first control loop configured to initially operate a fan at a first speed setting, increase the fan speed to a second speed setting upon the temperature of the zone exceeding a sum of a temperature set point and at least a portion of a temperature control band, and decrease the fan speed to the first speed setting upon the temperature of the one or more zones returning to the temperature set point; and
programming a second temperature control loop, the second control loop configured to maintain the temperature of the one or more zones at the temperature set point by decreasing the temperature of the air temperature control mechanism upon the temperature of the one or more zones exceeding a sum of the temperature set point and at least a portion of the control band, and increasing the temperature of the air temperature control mechanism upon the temperature of the one or more zones returning to the temperature set point.

18. The method of claim 17, wherein the first control loop is further configured to operate the fan at a third speed setting that is greater than the first speed setting and the second speed setting.

19. The method of claim 17, wherein the control band is approximately two degrees.

20. The method of claim 17, wherein the air temperature control mechanism comprises one or more water coils associated with a valve, and the second temperature control loop is further configured to control the position of the valve.
